(19) United States
(12) Patent Application Publication
(10) Pub. No.: US 2026/0269483 A1
(43) Pub. Date: Sep. 10, 2026

(54) CAVITY-BACKED SLOT ANTENNA DEVICE

(71) Applicant: ASUSTeK COMPUTER INC., Taipei City (TW)

(72) Inventors: Muhammad Idrees Magray, Taipei City (TW); Peng-Hao Juan, Taipei City (TW)

(21) Appl. No.: 19/539,505

(22) Filed: Feb. 13, 2026

(30) Foreign Application Priority Data
Mar. 4, 2025 (TW) 114107979

(51) Int. Cl. H01Q 13/18; H01Q 1/38; H01Q 13/10

(52) U.S. Cl. CPC H01Q 13/18; H01Q 1/38; H01Q 13/106

(57) ABSTRACT

A cavity-backed slot antenna device disposed in a metal casing is provided. The cavity-backed slot antenna device comprises a first cavity, an antenna substrate, a feed metal branch, a signal feed source, and a coupling metal branch. The first cavity of the cavity-backed slot antenna device includes a metal surface, and a non-conductive plane is provided on an open side of the first cavity. The first cavity is electrically connected to the metal casing and the non-conductive plane corresponds to an elongated opening of the metal casing. The antenna substrate is disposed on the non-conductive plane. The feed metal branch is disposed on the antenna substrate. The signal feed source is disposed on the antenna substrate and electrically connected to the feed metal branch. The coupling metal branch is disposed on the non-conductive plane and spaced apart from the antenna substrate to correspond to the signal feed source.

### CROSS-REFERENCE TO RELATED APPLICATION

This application claims the priority benefit of Taiwan application serial No. 114107979, filed on Mar. 4, 2025. The entirety of the above-mentioned patent application is hereby incorporated by reference herein and made a part of the specification.

### BACKGROUND OF THE INVENTION

### Field of the Invention

The invention relates to a cavity-backed slot antenna capable of sharing an opening of a speaker device.

### Description of the Related Art

Nowadays, consumers have increasingly high demand for product appearance. Since metal casings have advantages of structural durability, thermal performance, and aesthetics, all-metal bodies are increasingly applied to notebook computers to reduce large plastic openings or slots. However, conventional antennas, such as monopole antennas and slot antennas, are difficult to integrate into metal casings. The top bezel between an A-cover and B-cover of a notebook is usually too narrow (<3 mm) for antenna placement. Furthermore, the compact form factor of such devices presents additional challenges for antenna design.

Currently, a plastic opening is usually formed at the metal casing, or a slot is formed at a metal frame to accommodate the antenna to ensure stable wireless signal transmission. However, built-in antennas require considerable physical dimensions, and thus a size of the device is increased.

### BRIEF SUMMARY OF THE INVENTION

A cavity-backed slot antenna device is provided. The cavity-backed slot antenna device is disposed in a metal casing, the metal casing with an elongated opening, the cavity-backed slot antenna device comprises: a first cavity including a metal surface, wherein a non-conductive plane is provided at an open side of the first cavity, the first cavity is electrically connected to the metal casing through the metal surface, and the non-conductive plane corresponds to the elongated opening; an antenna substrate, disposed on the non-conductive plane of the first cavity; a feed metal branch, disposed on the antenna substrate; a signal feed source, disposed on the antenna substrate and electrically connected to the feed metal branch; and a coupling metal branch, disposed on the non-conductive plane and spaced apart from the antenna substrate to correspond to the signal feed source.

In summary, a cavity-backed slot antenna device is provided in embodiments. The elongated opening of a speaker is simultaneously regarded as the radiation aperture for the antenna, and thus a thin antenna device suitable for the metal casing of an electronic device (e.g., a notebook computer) is obtained. Since a plastic elongated opening or an additional slot for the antenna is not needed, the metal casing can have an all-metal design. Furthermore, the cavity-backed slot antenna device is integrated with the speaker device to share the elongated opening, the overall space required for the antenna within the electronic device is further reduced.

### BRIEF DESCRIPTION OF THE DRAWINGS

FIG. 1 is a structural schematic diagram of a cavity-backed slot antenna device according to an embodiment.

FIG. 2 is a structural schematic diagram of a cavity-backed slot antenna device and a speaker device disposed on an electronic device according to an embodiment.

FIG. 3 is a rear view of an electronic device according to an embodiment.

FIG. 4 is a structural schematic diagram of an integrated cavity-backed slot antenna device and a speaker device according to an embodiment.

FIG. 5 is an exploded schematic diagram of an integrated cavity-backed slot antenna device and a speaker device according to an embodiment.

FIG. 6 is a structural schematic diagram of an integrated cavity-backed slot antenna device and a speaker device according to an embodiment.

FIG. 7 is a simulated S-parameter diagram of a cavity-backed slot antenna device operating at different frequencies according to an embodiment.

### DETAILED DESCRIPTION OF THE EMBODIMENTS

Embodiments of the invention are illustrated accompanying diagrams, but not used to limit the invention. In addition, some components or structures are omitted in the diagrams to clearly show technical features of the invention. In the diagrams, same or similar numerals denote the same or similar components or circuits. Terms such as “first”, “second” are used to describe, various components, parts, regions or functions to distinguish one component, part, region or function from another.

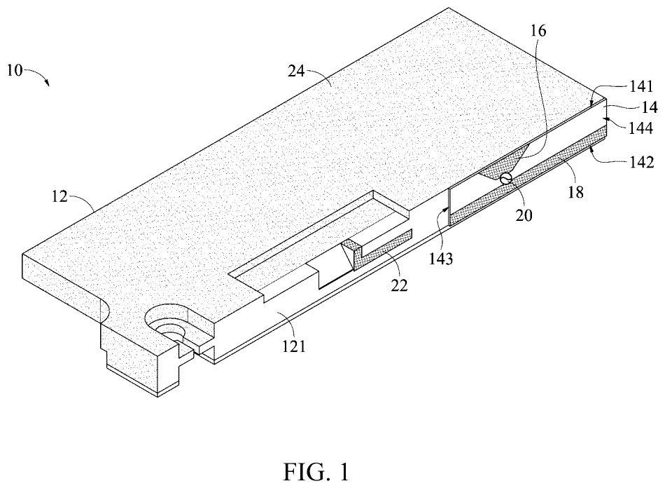

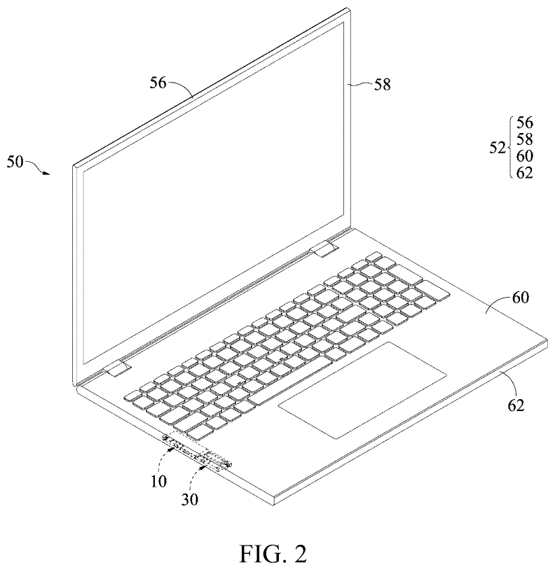

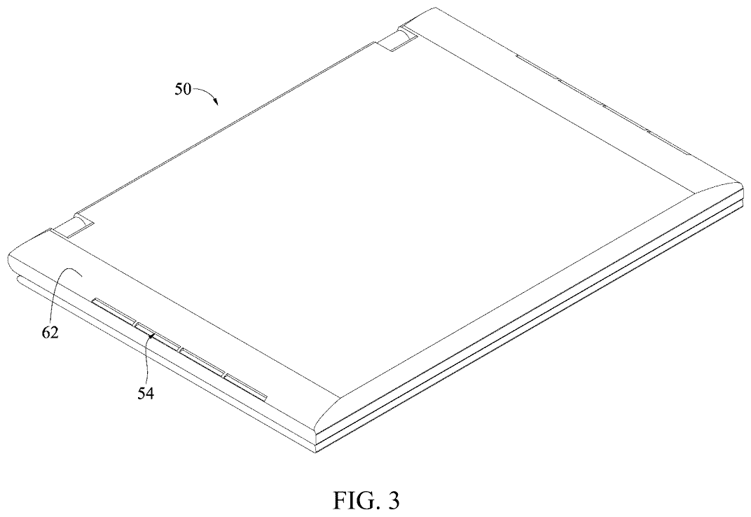

Referring to FIG. 1, FIG. 2, and FIG. 3, a cavity-backed slot antenna device 10 is disposed on a metal casing 52 of an electronic device 50. The metal casing 52 is provided with an elongated opening 54, and the cavity-backed slot antenna device 10 transmits and receives wireless radio frequency (RF) signals through the elongated opening 54. The elongated opening 54 serves as both a radiation aperture of the antenna and an acoustic opening of a speaker device 30. The cavity-backed slot antenna device 10 includes a first cavity 12, an antenna substrate 14, a feed metal branch 16, a ground portion 18, a signal feed source 20, and a coupling metal branch 22.

As shown in FIG. 1, FIG. 2, and FIG. 3, in the cavity-backed slot antenna device 10, the first cavity 12 includes a metal surface 24. A non-conductive plane 121 is provided on an open side of the first cavity 12. That is, except for the non-conductive plane 121, other surfaces of the first cavity 12 are the metal surface 24. The first cavity 12 is electrically connected to the metal casing 52 through the metal surface 24, and the non-conductive plane 121 corresponds to the elongated opening 54. The antenna substrate 14 is disposed on the non-conductive plane 121 of the first cavity 12. The antenna substrate 14 includes a first long side 141 and a second long side 142 opposed to each other, and a first short side 143 and a second short side 144 opposed to each other. In this embodiment, the first long side 141 and the second long side 142 are two opposite long edges of the non-conductive plane 121. The second short side 144 is a short edge of the non-conductive plane 121. The feed metal branch 16 is disposed on the antenna substrate 14 and extends along the first long side 141. In one embodiment, the feed metal branch 16 is a T-shaped metal branch. The ground portion 18 is also disposed on the antenna substrate 14, extends along the second long side 142, and is connected to the metal surface 24. The signal feed source 20 is disposed on the antenna substrate 14. One end of the signal feed source 20 is electrically connected to the feed metal branch 16, and the other end is electrically connected to the ground portion 18. The coupling metal branch 22 is directly disposed on the non-conductive plane 121 and electrically connected to the metal surface 24. The coupling metal branch 22 is spaced apart from the antenna substrate 14 and positioned adjacent to the first short side 143 of the antenna substrate 14, such that the coupling metal branch 22 corresponds to the signal feed source 20 to increase coverage in the 5 GHz frequency band. In one embodiment, the coupling metal branch 22 is a quarter-wavelength L-shaped stub. Therefore, when the cavity-backed slot antenna device 10 is assembled to the metal casing 52, the first cavity 12 is served as a resonator to support energy coupling to standing waves of the slot. With the cooperation of the first cavity 12, the feed metal branch 16, and the coupling metal branch 22, wireless frequency signals are received or transmitted to support the 2.4 G, 5 G, and 6 G frequency bands.

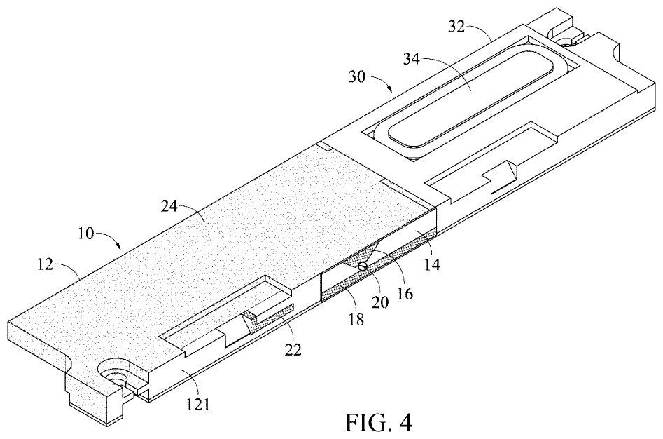

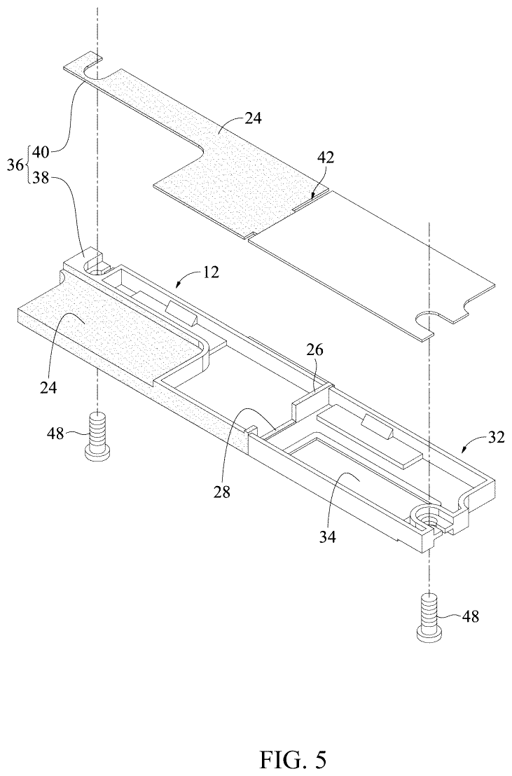

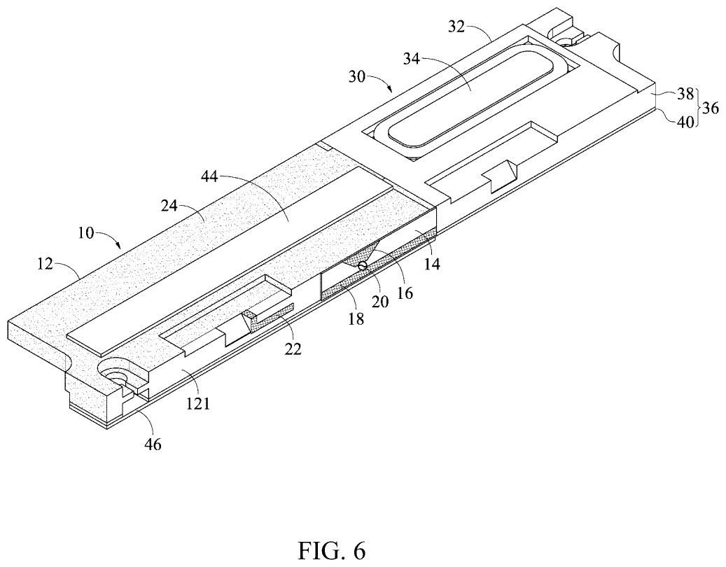

In one embodiment, the cavity-backed slot antenna device 10 is integrated with a speaker device 30. Referring to FIG. 2, FIG. 3, FIG. 4, and FIG. 5, a second cavity 32 is formed adjacent to a side of the first cavity 12. A speaker module 34 is disposed in the second cavity 32 and corresponds to the elongated opening 54 to form a speaker device 30. The speaker module 34 is exposed from the second cavity 32. A metal sidewall 26 is shared between the first cavity 12 and the second cavity 32. A notch 28 is formed at the metal sidewall 26 to allow airflow between the first cavity 12 and the second cavity 32. In an embodiment, the width of the notch 28 is larger than the width of the speaker module 34 (the speaker unit). The first cavity 12 of the cavity-backed slot antenna device 10 and the second cavity 32 of the speaker device 30 share a housing 36. The housing 36 is an LDS (Laser Direct Structuring) housing. The housing 36 is divided into the first cavity 12 and the second cavity 32 via the metal sidewall 26. The housing 36 includes a first housing 38 and a second housing 40. The non-conductive plane 121, the antenna substrate 14, the feed metal branch 16, the ground portion 18, the signal feed source 20, and the coupling metal branch 22 are disposed on the first housing 38. The metal sidewall 26 is also disposed on the first housing 38. The metal sidewall 26 slightly protrudes from the peripheral frames of the first housing 38. Two clamping slots 42 are formed on the second housing 40 corresponding to the metal sidewall 26. When the first housing 38 and the second housing 40 are assembled, the metal sidewall 26 of the first housing 38 is clamped into the clamping slots 42 of the second housing 40, and then the housing 36 with the first cavity 12 and the second cavity 32 is formed. As shown in FIG. 2, FIG. 5, and FIG. 6, when the cavity-backed slot antenna device 10 is assembled to the metal casing 52, the first housing 38 is connected to the metal casing 52 via a first conductive gasket 44, and the second housing 40 is connected to the metal casing 52 via a second conductive gasket 46.

The electronic device 50 is a notebook computer or a tablet computer. In one embodiment, as shown in FIG. 2, FIG. 3, and FIG. 6, the electronic device 50 is a notebook computer. The metal casing 52 includes a screen metal back cover (commonly referred to as A-cover) 56, a screen metal front cover (commonly referred to as B-cover) 58, a keyboard metal cover (commonly referred to as C-cover) 60, and a keyboard metal base (commonly referred to as D-cover) 62. The cavity-backed slot antenna device 10 and the integrated speaker device 30 are assembled between the keyboard metal base 62 and the keyboard metal cover 60, such that the first housing 38 is connected to the keyboard metal base 62 via the first conductive gasket 44, and the second housing 40 is connected to the keyboard metal cover 60 via the second conductive gasket 46. Furthermore, the shared elongated opening 54 is located at a bottom side edge of the keyboard metal base 62 to allow the cavity-backed slot antenna device 10 to transmit and receive radio frequency signals through the elongated opening 54, and to allow the speaker device 30 to output sound signals through the elongated opening 54. In an embodiment, the elongated opening 54 is also formed at a side edge of the keyboard metal base 62 corresponding to the cavity-backed slot antenna device 10 and the speaker device 30.

In one embodiment, referring to FIG. 2, FIG. 5, and FIG. 6, the shared housing 36 is assembled to the metal casing 52 via at least two fastening elements 48, such as screws or bolts. That is, the housing 36 is assembled to the keyboard metal cover 60 of the metal casing 52 via the fastening elements 48. The second conductive gasket 46 is disposed between the housing 36 (the second housing 40) and the keyboard metal cover 60 to provide electrical conduction and buffering.

In one embodiment, the first housing 38 is integrally formed, and the second housing 40 is also integrally formed. Thus, the first housing 38 and the second housing 40 are assembled to form the housing 36 which is served as the first cavity 12 and the second cavity 32.

In one embodiment, the metal surface 24 is made of a metal material. For example, the metal material is silver, copper, nickel, tin, iron, aluminum, or an alloy thereof, which is not limited herein.

In one embodiment, referring to FIG. 4, the feed metal branch 16 and the ground portion 18 are printed on the antenna substrate 14. In one embodiment, the antenna substrate 14 is a PCB (printed circuit board), a FPC (flexible printed circuit) board, a laser-engraved substrate, or a rigid-flex composite substrate, which is not limited herein.

In one embodiment, the feed metal branch 16 and the coupling metal branch 22 are made of a metal material. The metal material is silver, copper, nickel, tin, iron, aluminum, or an alloy thereof, which is not limited thereto.

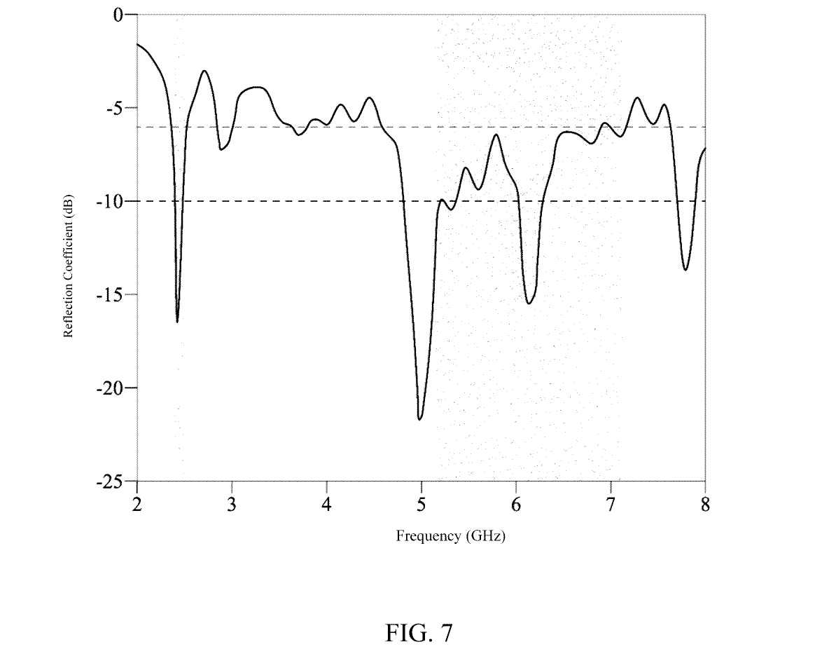

Referring to FIG. 4 and FIG. 7, with the cooperation of the feed metal branch 16, the coupling metal branch 22, and the first cavity 12, resonance is generated to excite the cavity-backed slot antenna device 10 to form resonant modes in the 2.4 G, 5 G, and 6 G frequency bands, respectively. As shown in FIG. 7, an S-parameter (S11) simulation was performed on the cavity-backed slot antenna device 10 shown in FIG. 4, and an external dimension of the cavity-backed slot antenna device 10 is 60 mm×22 mm×4.3 mm. The S-parameter simulation results are shown in FIG. 7. As the curves shown in the figure, the reflection coefficients (S11) for both the low-frequency resonant mode and the high-frequency resonant mode are less than −6 dB (S11<−6 dB), and even less than −10 dB, which shows that the cavity-backed slot antenna device 10 has good reflection coefficients in both low-frequency and high-frequency operating bands.

According to the cavity-backed slot antenna device in embodiments, interference with components of the electronic device (e.g., a notebook computer) is greatly reduced through the three metal walls of the first cavity. Furthermore, the radiation pattern perpendicular to the surface of the first cavity (the slot) is similar to that of the slot antenna pattern in the XY plane. Therefore, by utilizing the original linear elongated opening on the metal casing, the size of the cavity-backed slot antenna device is also reduced. Besides the integrity of the overall appearance, operating bandwidths for a Wireless Local Area Network (WLAN) system (low-frequency band: 2400-2480 MHz; high-frequency band: 5150-7150 MHz) are also obtained. Consequently, the cavity-backed slot antenna device has significant efficiency and gain in both the low-frequency and high-frequency bands.

In summary, a cavity-backed slot antenna device is provided in embodiments. The elongated opening of a speaker is simultaneously regarded as the radiation aperture for the antenna, and thus a thin antenna device suitable for the metal casing of an electronic device (e.g., a notebook computer) is obtained. Since a plastic elongated opening or an additional slot for the antenna is not needed, the metal casing can have an all-metal design. Furthermore, the cavity-backed slot antenna device is integrated with the speaker device to share the elongated opening, the overall space required for the antenna within the electronic device is further reduced.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A cavity-backed slot antenna device, disposed in a metal casing with an elongated opening, the cavity-backed slot antenna device comprising:
a first cavity including a metal surface, wherein a non-conductive plane is provided at an open side of the first cavity, the first cavity is electrically connected to the metal casing through the metal surface, and the non-conductive plane corresponds to the elongated opening;
an antenna substrate, disposed on the non-conductive plane of the first cavity;
a feed metal branch, disposed on the antenna substrate;
a signal feed source, disposed on the antenna substrate and electrically connected to the feed metal branch; and
a coupling metal branch, disposed on the non-conductive plane and spaced apart from the antenna substrate to correspond to the signal feed source.

2. The cavity-backed slot antenna device according to claim 1, wherein a second cavity is further provided at a side of the first cavity, a speaker module is disposed in the second cavity corresponding to the elongated opening to form a speaker device, a metal sidewall is shared between the first cavity and the second cavity, and the metal sidewall includes a notch.

3. The cavity-backed slot antenna device according to claim 2, wherein the first cavity and the second cavity share a housing, and the housing is divided into the first cavity and the second cavity via the metal sidewall.

4. The cavity-backed slot antenna device according to claim 3, wherein the housing further comprises a first housing and a second housing, and the non-conductive plane, the antenna substrate on the non-conductive plane, the feed metal branch, the signal feed source, and the coupling metal branch are disposed on the first housing.

5. The cavity-backed slot antenna device according to claim 4, wherein the first housing is connected to the metal casing through a first conductive gasket, and the second housing is connected to the metal casing through a second conductive gasket.

6. The cavity-backed slot antenna device according to claim 5, wherein the metal casing further comprises a keyboard metal base and a keyboard metal cover, the first housing is connected to the keyboard metal base through the first conductive gasket, and the second housing is connected to the keyboard metal cover through the second conductive gasket.

7. The cavity-backed slot antenna device according to claim 6, wherein the elongated opening is formed at a side edge or a bottom side edge of the keyboard metal base.

8. The cavity-backed slot antenna device according to claim 3, wherein the housing is an LDS (Laser Direct Structuring) housing.

9. The cavity-backed slot antenna device according to claim 3, wherein the housing is assembled on the metal casing through at least two fastening elements.

10. The cavity-backed slot antenna device according to claim 1, wherein the cavity-backed slot antenna device further comprises a ground portion disposed on the antenna substrate and connected to the metal surface, and the ground portion is electrically connected to the signal feed source.

11. The cavity-backed slot antenna device according to claim 1, wherein the feed metal branch is a T-shaped metal branch.

12. The cavity-backed slot antenna device according to claim 1, wherein the coupling metal branch is a quarter-wavelength L-shaped stub.
